(19) United States
(12) Patent Application Publication
(10) Pub. No.: US 2005/0143152 A1
(43) Pub. Date: Jun. 30, 2005

(54) Wireless earphone with incoming call vibration function

(76) Inventor: Wen Hsiang Yueh, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/747,177

(22) Filed: Dec. 30, 2003

(51) Int. Cl. H04M 1/00

(52) U.S. Cl. 455/575.6

(57) ABSTRACT

A wireless earphone with incoming call vibration function that uses a DSP to produce a driving signal to drive a vibrator for warning of the incoming call. The wireless earphone has a wireless communication module receiving a remote data signal and replying a modulation signal. A DSP is coupled to the wireless communication module, an earphone and a microphone for processing digital signal. A driving circuit is coupled to the DSP for receiving a driving signal. A is vibrator coupled to the DSP for providing an intermittent or continuous warning function according to the driving signal.

### BACKGROUND OF THE INVENTION

1. Field of the Invention

The present invention relates to a wireless earphone with incoming call vibration, more specifically, relates a wireless bluetooth earphone with the incoming call vibration function.

2. Description of the Related Art

Bluetooth is a technique for low cost, low power and short distance wireless communication that can be applied to any personal mobile communication device. For example, the bluetooth can be used to design a wireless earphone, a portable cell phone watch and a communication device worn on a finger. These products not only can be used for wireless communication but can also provide the functions of browsing on the Internet and receiving/sending e-mail if they have a bluetooth chip built in.

There are diverse kinds of bluetooth wireless earphones on the market. These earphones are with a bluetooth cell phone. The incoming call signal of the bluetooth cell phone is wireless-transmitted to the bluetooth wireless earphone by bluetooth communication technique, and the voice signal is transmitted through the bluetooth wireless earphone to the bluetooth cell phone by bluetooth communication technique to achieve a full duplex communication. However the bluetooth wireless earphone is portable and can be used separate from a bluetooth cell phone; therefore the people often leave the bluetooth cell phone someplace and only carry the bluetooth wireless earphone. The incoming call signal is often missed because of the outside noise.

### SUMMARY OF THE INVENTION

The primary object of the present invention is to provide a wireless earphone with an incoming call vibration function that can be installed in a vibrator in a wireless earphone and process the incoming call signal to drive the vibrator to make an incoming call alert action.

The present invention provides a wireless earphone with an incoming call vibration function that uses the wireless communication module to receive the incoming call signal and processes the incoming call signal to control the driving circuit with the DSP, after which the driving circuit produces the driving signal to drive the vibrator and produce the effect of the incoming call warning.

### BRIEF DESCRIPTION OF THE DRAWINGS

The various objects and advantages of the present invention will be more readily understood from the following detailed description when read in conjunction with the appended drawing, in which:

FIG. 1 is a framework diagram of the communication of the present invention;

FIG. 2 is a circuit block diagram of the wireless earphone with incoming call vibration function of the present invention.

### DETAILED DESCRIPTION OF PREFERRED EMBODIMENTS

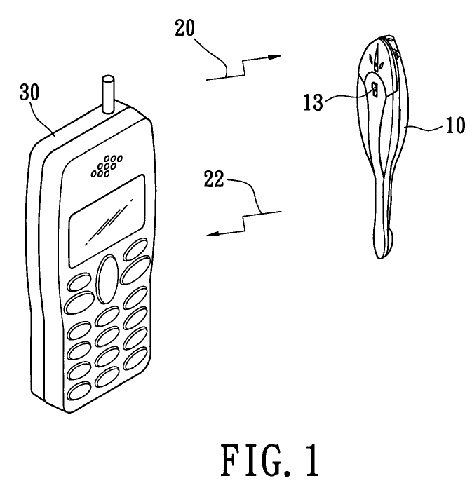

FIG. 1 is a schematic diagram of the present invention. The present invention is a wireless earphone 10 with an incoming call vibration function. The wireless earphone 10 can communicate with a bluetooth cell phone 30, and can turn on or turn off the incoming call warning function thereof by an operating a switch 13.

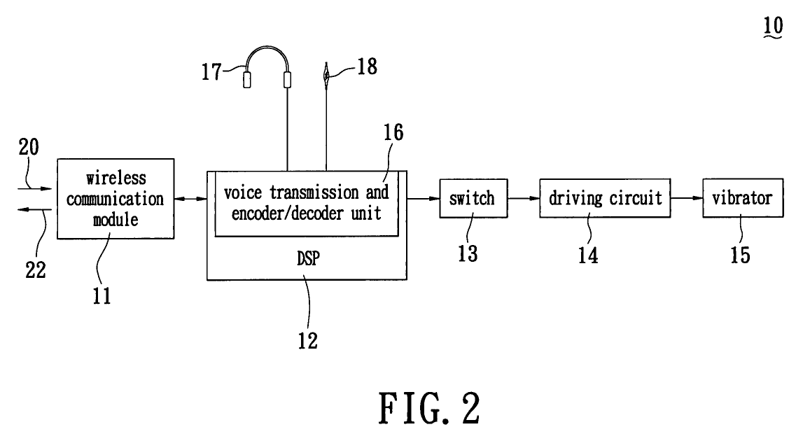

FIG. 2 is a block diagram of the wireless earphone with an incoming call vibration function according to the present invention. The present invention provides a wireless earphone 10 with an incoming call vibration function. The wireless earphone 10 informs a user of the incoming call by driving a vibrator 15 in earphone in response to an incoming call signal. Moreover the wireless earphone 10 comprises a wireless communication module 11, a DSP 12, a switch 13, a driving circuit 14, a vibrator 15, a voice transmission and encoder/decoder unit 16, an earphone 17 and a microphone 18.

Referring to FIG. 2, the wireless communication module 11 is coupled to the DSP 12 for receiving a remote data signal 20 and replying with a modulation signal 22, in which the remote data signal 20 is an incoming call signal.

When a call is incoming, the wireless communication module 11 receives the incoming call signal, and then the incoming call signal is processed by the DSP 12 so as to output a control signal to control the driving circuit 14 coupled to the DSP 12. Moreover, the driving circuit 14 produces the driving signal to drive the vibrator 15 to achieve the warning function for the income-call. In above, the driving circuit 14 is a transistor driving circuit that consists of a transistor and a resistor. The base of the transistor is connected to the DSP 12 through the resistor, whereby the transistor is controlled by the DSP 12. The vibrator 15 is connected to the emitter of the transistor and has intermittent or continuous vibration for warning. Moreover, at the same time, the wireless communication module 11 receives the remote data signal 20 and the remote data signal 20 is decoded by the DSP 12. After being decoded by a voice transmission and encoder/decoder unit 16 of the DSP 12, the voice signal can be heard clearly through the earphone 17. In response, a reply voice signal can be sent through the microphone 18 into the voice transmission and encoder/decoder unit 16 of the DSP 12 encodes the reply voice signal. After encoding the reply signal, the reply signal is transmitted to the wireless communication module 11 and a modulation signal 22 is replied to a remote bluetooth cell phone 30.

The wireless earphone with incoming call vibration function of the present invention processes the incoming call signal by DSP 12 and controls the driving circuit 14 coupled to the DSP 12 so as to produce the driving signal to drive the vibrator 15 to achieve the warning function of the income-call. Moreover, the wireless earphone 10 uses the wireless communication module 11 to complete the full duplex communication, in which the wireless communication module 11 is a bluetooth communication module.

FIG. 2 is a circuit block diagram of the wireless earphone with incoming call vibration function according to the present invention. The switch 13 is coupled to the DSP 12 and the driving circuit 14 for controlling the on/off of the driving circuit 14 so as to turn on or turn off the vibrator 15. The switch 13 is a dipswitch that can be used to achieve the best effect of saving power.

Therefore the wireless earphone with incoming call vibration function according to the present invention could use the wireless communication module 11 to receive the incoming call signal and control the driving circuit 14 according to the processed incoming call signal by the DSP 12. Moreover, the driving circuit 14 transmits the driving signal to drive the vibrator 15 to produce the warning action of the income-call. Therefore, the wireless earphone with incoming call vibration function according to the present invention solves the problem of low warning sound in the wireless bluetooth earphone.

Although the present invention has been described with reference to the preferred embodiment thereof, it will be understood that the invention is not limited to the details thereof. Various substitutions and modification have suggested in the foregoing description, and other will occur to those of ordinary skill in the art. Therefore, all such substitutions and modifications are intended to be embraced within the scope of the invention as defined in the appended claims.

1. A wireless earphone with incoming call vibration function having an earphone body and a microphone, comprising:
a wireless communication module receiving a remote data signal and replying with a modulation signal;
a DSP coupled to said wireless communication module, said earphone and said microphone for processing a digital signal;
a driving circuit coupled to said DSP for receiving a driving signal; and
a vibrator coupled to said driving circuit for producing an intermittent and a continuous warning action according to said driving signal.

2. The wireless earphone of claim 1, wherein said wireless communication module is a bluetooth communication module.

3. The wireless earphone of claim 1, wherein said DSP comprises a voice transmission and encoder/decoder unit for encoding and decoding the voice and converting digital data and analog data.

4. The wireless earphone of claim 1, wherein a switch is coupled to said DSP and said driving circuit for controlling said driving circuit to turn on/off a warning action of incoming call vibration of the vibrator.

5. The wireless earphone of claim 4, wherein said switch is a dipswitch.

6. The wireless earphone of claim 1, wherein said driving circuit is a transistor driving circuit.
